(19) United States
(12) Patent Application Publication
(10) Pub. No.: US 2025/0005174 A1
(43) Pub. Date: Jan. 2, 2025

(54) AUTHORIZED PERMISSION STATUS FOR RESTRICTED INFORMATION

(71) Applicant: Lenovo (United States) Inc., Morrisville, NC (US)

(72) Inventors: Allen Richey, Frisco, TX (US); Matthew Fardig, Boonville, IN (US); Inna Zolin, Cary, NC (US)

(21) Appl. No.: 18/345,367

(22) Filed: Jun. 30, 2023

(51) Int. Cl. G06F 21/60; H04M 1/72454

(52) U.S. Cl. CPC G06F 21/604; H04M 1/72454

(57) ABSTRACT

One embodiment provides a method, the method including: receiving, at an information handling device in operative communication with a central device during a predetermined time period, context data of a user of the information handling device; identifying, from the context data and utilizing a software management system, that a permission status of the user from the central device restricts access of the user to an application on the information handling device during the predetermined time period; and allowing, responsive to the central device adjusting the permission status of the user based upon the context data of the user, the user to access to the application. Other aspects are claimed and described.

### BACKGROUND

In certain environments, access to applications and/or additional software may be deemed inappropriate based upon the location in which they are being accessed within. For example, when present at a school, access to social media resources and video software may be restricted for students during class periods to assist the student in focusing on the material currently being taught. Negating potential distractions may increase productivity. Software and additional resources accessible through an information handling device may be predetermined and outlined on a list of restrictions based on a network-type associated with the environment. Referring back to the school example, restrictions at a user device may be established when the user device is connected to a wireless network operated by the school.

### BRIEF SUMMARY

In summary, one aspect provides a method, the method including: receiving, at an information handling device in operative communication with a central device during a predetermined time period, context data of a user of the information handling device; identifying, from the context data and utilizing a software management system, that a permission status of the user from the central device restricts access of the user to an application on the information handling device during the predetermined time period; and allowing, responsive to the central device adjusting the permission status of the user based upon the context data of the user, the user to access to the application.

Another aspect provides an information handling device, the information handling device including: a processor; a memory device that stores instructions that, when executed by the processor, causes the information handling device to: receive, at the information handling device in operative communication with a central device during a predetermined time period, context data of a user of the information handling device; identify, from the context data and utilizing a software management system, that a permission status of the user from the central device restricts access of the user to an application on the information handling device during the predetermined time period; and allow, responsive to the central device adjusting the permission status of the user based upon the context data of the user, the user to access to the application.

A further aspect provides a product, the product including: a computer-readable storage device that stores executable code that, when executed by a processor, causes the product to: receive, at an information handling device in operative communication with a central device during a predetermined time period, context data of a user of the information handling device; identify, from the context data and utilizing a software management system, that a permission status of the user from the central device restricts access of the user to an application on the information handling device during the predetermined time period; and allow, responsive to the central device adjusting the permission status of the user based upon the context data of the user, the user to access to the application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for permitting access to software based on context data of the user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In an environment where a plurality of user devices are connected to a central device, the central device can control information that is accessible to the user devices. The most common environment is a learning or educational environment, where a teacher or other instructor controls the central device and each of the students utilizes one or more of the user devices. When dictating the websites or applications that can be accessed by the user devices, the central device can not only dictate which websites or applications that can be accessed by the user devices, but can also dictate when the website or application becomes accessible. Conversely, the central device can dictate which applications cannot be accessed during a particular time period.

Conventional classroom management software requires that the central device user set the restrictions ahead of time for a particular time period. Generally, the central device user restricts all applications and then identifies which ones are allowed during the time period. If the central device user wants to allow access to a particular restricted application during the time period, the central device user has to interact with the central device and push applications or lift restrictions to applications when desired. This is referred to as a push request in conventional classroom management software. However, this requires the central device user, also referred to as an instructor for ease of readability, to stop instructing, interact with the central device, select the application to be allowed, and then resume instructing. This not only takes time away from the instructing, but also interrupts the flow of the instructing. Thus, this conventional system is clunky, inefficient, and disruptive in order to allow access to a restricted application. Other than the push request, the other conventional technique for addressing this problem are controls that allow the instructor to set up times within the time period that a particular application would be allowed. However, this requires either large windows of time to be set up, which can interfere with the teaching, or a well choreographed lesson plan where the instructor knows exactly when the application will need to be accessed. Not only is this somewhat impractical, but this also does not allow for any spontaneous need for a particular application.

Accordingly, the described system and method provides a technique for permitting access to software after receiving context data of a user and determining, from the context data, that the user should be able to access the software. The system may receive at an information handling device that is in operative communication with a central device during a predetermined time period context data of a user. The context data may be received from at least one sensor. The software management software may identify a permission status of the user as set by the central device restricts access to an application on the device during a predetermined time period. Based upon the context data, the system may determine that the user should have access to the application, adjust the permission status of the user at the central device, and thereafter allow access to the application. Thus, the described system allows a technique to allow access to a restricted application in an on-the-fly manner without requiring an instructor to stop teaching and allow access to the application, thereby resulting a system that is less disruptive, more efficient, and more user friendly than conventional techniques. The described system thereby allows for spontaneous allowance of restricted applications which is not allowed using conventional systems.

The illustrated example embodiments will be best understood by reference to the figures. The following description is intended only by way of example, and simply illustrates certain example embodiments.

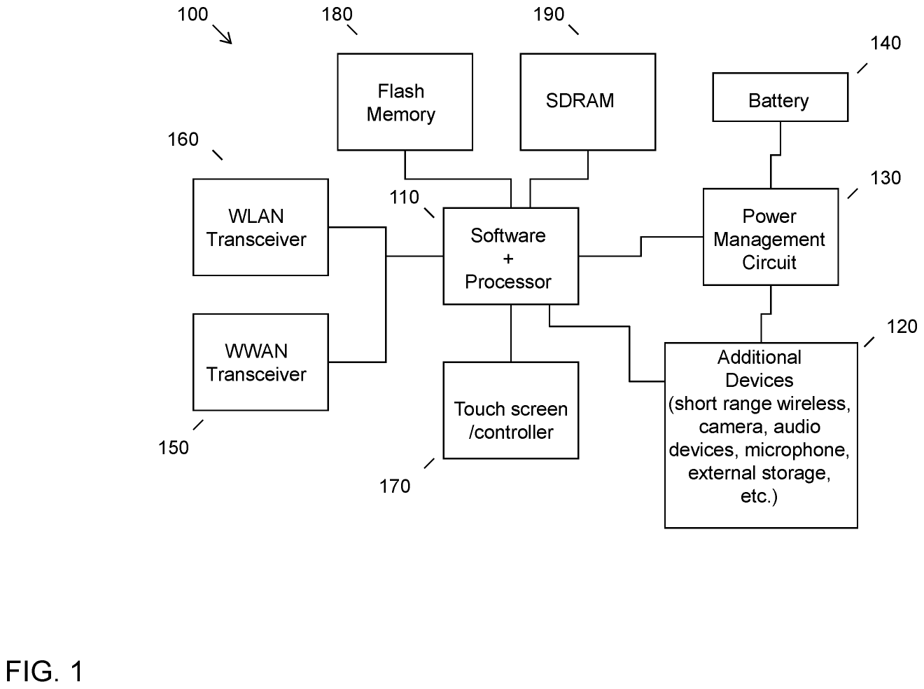

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

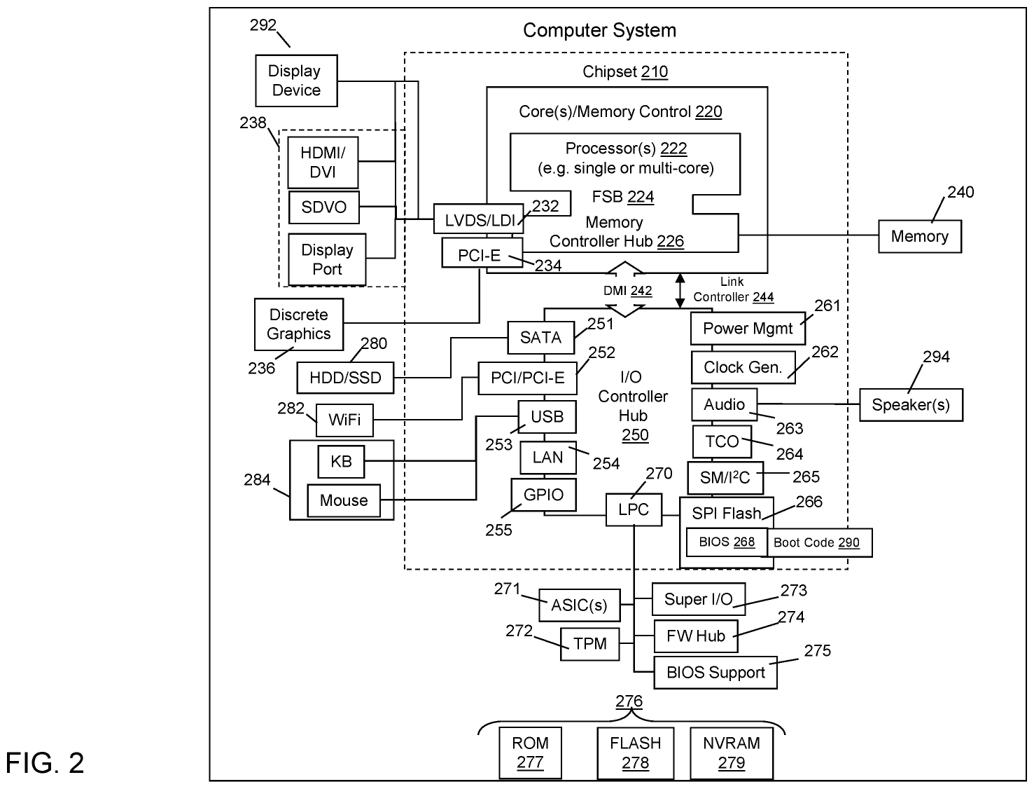

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in a system that receives context data of a user and thereafter permits access to previously restricted software. For example, the circuitry outlined in FIG. 1 may be implemented in a tablet or smart phone embodiment, whereas the circuitry outlined in FIG. 2 may be implemented in a personal computer embodiment.

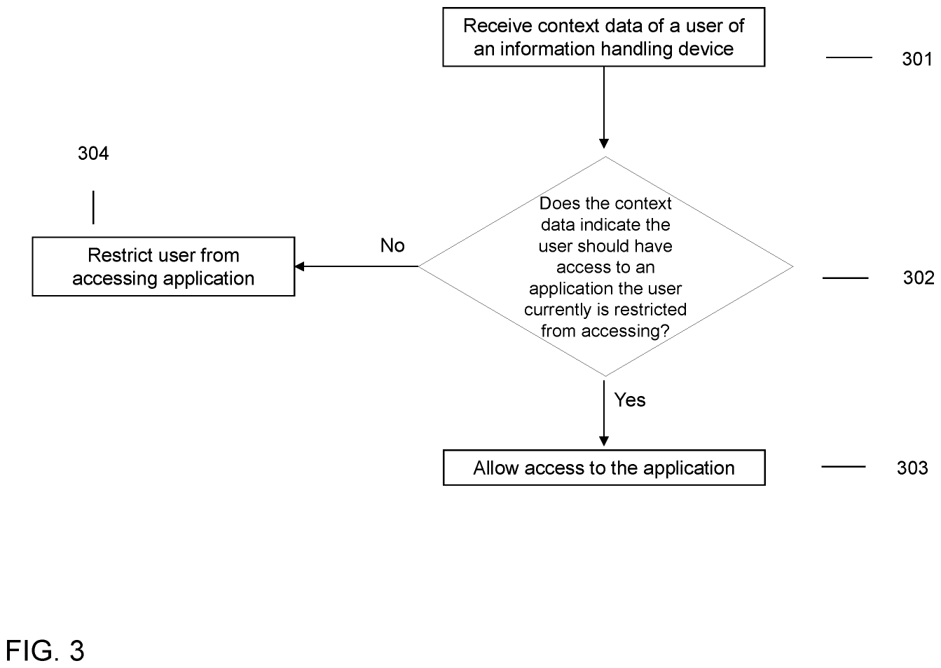

FIG. 3 illustrates an example method for determining a permission status of a user attempting to access software, and thereafter permitting access to the restricted software based upon context data of a user. The method may be implemented on a system which includes a processor, memory device, output devices (e.g., display device, etc.), input devices (e.g., keyboard, touch screen, mouse, microphones, sensors, biometric scanners, etc.), and/or other components, for example, those discussed in connection with FIG. 1 and/or FIG. 2. While the system may include known hardware and software components and/or hardware and software components developed in the future, the system itself is specifically programmed to perform the functions as described herein to permit access to software by using a software management system to determine a permission status of user of an information handling device based on received context data of a user.

The software management system may run in the background of an information handling device and may be activated when the device is activated. Additionally, or alternatively, the system may be activated when an application (e.g., website, database, calendar, control panel, etc.) requiring authorization is activated, detected, or otherwise opened. The software management system may also be activated when devices that are designated as being part of a system or group are activated or active. For example, in the educational environment, the software management system may be activated when the central device is activated, one or more of the user devices are activated, a combination thereof, and/or the like. The system may also be activated upon receiving context data at the information handling device associated with one or more applications that have currently restricted access. In this case, the software management system may not be activated until at least a portion of context data of a user is received.

Once the software management system is activated on a device, the system may be utilized throughout the described method. Continued use of the software management system through receiving context data and adjusting the permission status of the user will train the software management software in producing more accurate permission status changes and allowance of access to a restricted application. Thus, to perform the method present in the software management system and in order to accurately determine whether a permission status of the user attempting to access an application on an information handling device should be changed, the software management system may utilize a neural network, machine-learning model, and/or other learning algorithm or artificial intelligence, collectively referred to as a machine-learning model for ease of readability. The machine-learning model can be trained utilizing previously allowed or changed permissions for accessing restricted application, and context data of a user at a time of attempting to access the application. In other words, the machine-learning model is given access to previously received context data and permission statuses changed based upon context data received. The context data, identified permission statuses, and the previous permitting of accessing applications or permission status changes are referred to as a training dataset and can be used to train the machine-learning model so that it can make more accurate predictions over time.

Using the training dataset, which may change over time, the machine-learning model learns nuances between context data received, permission statuses identified, and changed permission statuses at an information handling device. This results in more accurately identifying in which contexts a user may be permitted to access restricted applications, software, and/or data. For example, the machine-learning model can learn in what contexts may an application may be acceptable to access and in which contexts may the same piece of application remain restricted. As information is determined based upon the context data received and the application type attempting to be viewed, the machine-learning model can learn additional nuances and become more accurate and refined over time. Thus, while there is an initial training dataset that is used to initially train the machine-learning model, the machine-learning model is learning over time based upon new information received by the machine-learning model, thereby evolving to become more accurate. It should also be noted that the refinement over time may be automatically performed by the machine-learning model by ingesting feedback, which includes changes to the training dataset, input by users, feedback provided by users, and/or the like. The ingested feedback can be utilized by the model to automatically refine predictions made by the model.

For ease of readability, the environment and scenario that will be discussed is that of an educational environment where the instructor or teacher controls the central device and the students or pupils control the user devices. The instructor can set the restrictions on the central device and the central device pushes these restrictions to the user devices, thereby restricting access to applications. In practice, the system may assume that all applications are restricted unless allowed access is identified by the central device. However, this is not strictly necessary. This scenario allows the instructor to provide an indication of which applications should be allowed as opposed to providing an indication of which applications should be restricted, where the allowed applications may be a much smaller list. However, this disclosure is not limited to just an educational environment, as the software management system can be deployed in any environment that includes a central device and operatively coupled user devices. For example, the system could be deployed in a work environment where a central device may be operated by a manager, presentation presenter, group lead, and/or the like, and the user devices are operated by employees who report to the manager, users watching the presentation, other group members, and/or the like. As another example, the system could be deployed in a customer service environment, where the customer service representative controls the central device and the customer controls the user device or vice versa.

It should be noted that applications or software may be restricted at a user device at one point in time and may be allowed at a different point in time. For example, if the user device is located away from an educational environment, the user may have access to all software or applications. On the other hand, when the user device is located within the educational environment, the user may only have access to one or two applications with all remaining applications being restricted. Thus, the described system works to automatically allow access to an application when it would normally be under a restricted access.

At 301, the system may receive context data of a user at an information handing device. This information handling device will also be referred to as the user device in order to distinguish it from the central device. However, both the user device and the central devices may be information handling devices (e.g., tablets, laptop computer, desktop computer, smart watches, smart phones, smart boards, etc.). As previously described, the user device(s) is in operative communication with the central device during a predetermined time period. Utilizing the educational example, the predetermined time period may be a scheduled class length. The central device provides the instructions to the user devices to restrict access to the applications that have been identified at the central device by the instructor. Thus, during this time period, the user devices are unable to access any applications that are not allowed by the central device. In other words, the central device sets a permission status for the user and, therefore, the user device, in relation to one or more applications.

In addition to the context data, the software management system may receive input data from the user. The input data includes data that indicates a user is attempting to access an application (also referred to as software) on the user device. The input data may include object selection (e.g., image, hyperlink, application icon, etc.) that is provided in order to open, manipulate, or otherwise access, an application. The input data may include user selection data that includes, but is not limited to, selection using a mechanical device (e.g., mouse, keyboard, trackpad, touchscreen, etc.), audio input (e.g., audible command received at digital assistant, etc.), visual input (e.g., gaze-based commands, etc.), gesture input (e.g., finger pointing at a display, sign language input, etc.), secondary device input (e.g., accessing something on one device that causes an application to open on a second device, etc.), a combination thereof, and/or the like. In this system, any version of a user input may be utilized; however, for ease of understanding, throughout this application reference may be made to object selection by use of a computer mouse. However, this is a non-limiting example.

Context data is data identifying a context of the user of an information handling device. The context data identifies where a user is located, what the user is doing, what other users in the area are doing, and/or the like. In other words, context data is any data that can be utilized by the system to assist in identifying whether the user should have access to the application the user is attempting to access. Context data may be received by one or more sensors integral to and/or operatively coupled to the information handling device in use. Thus, the sensors may include global positioning sensor (GPS) sensors, accelerometers, proximity sensors, short range wireless sensors, near field sensors, touch sensors, image sensors, audio sensors, gyroscopes, and/or the like. Such sensors may capture where a user currently located and specifics about the environment the user is located in (e.g., high traffic, low traffic, audio levels, privacy, location, other users and proximity, etc.). This collection of context data can happen in both real-time and using historical sensor data. For example, the system may continually collect sensor data to identify the context of the user, but only update the sensor data if the sensor detects a change in the data. Thus, the context data represents a real-time context of the user.

The system may utilize other information to identify the context of the user other than simply sensor data. Another type of information includes information received or accessed from secondary applications associated with the user, other users, the central device user, and/or the like. An example of context data received from a secondary application is data received from an Internet browser, Intranet browser, hyperlink, and/or the like. This context data may identify an application that a user is attempting to access. As another example, the context data may be associated with schedule data of the user. Schedule data of the user may include information about events that a user is scheduled to participate in. Thus, receipt of this information or data may include receipt of information from a secondary application such as a user's calendar or other scheduling application, a user's text messaging application, a user's email application, a user's social media application, data from other user devices, a combination thereof, and/or the like.

In the system, accessing scheduling applications, messaging applications, and/or the like, may provide the system with time periods specific to application use. For example, if a student's calendar shows that there is a time period scheduled for e-gaming, the system may recognize software and/or applications that are directly related to this time period that may not be accessible at separate times of the student's day. As a continued example, resources containing sensitive materials that are uncommonly accessible but are considered relevant during an established time period may also be recognized by the system. In other words, the information from the secondary applications may assist in identifying the context of the user and, therefore, may be utilized to determine applications the user may need to access.

Another example of context data includes data that identifies a task of the user during the predetermined time period. To identify the task, the software management system may employ a task recognition technique. Recognizing a task may be facilitated utilizing a machine-learning model that is able to take inputs regarding user actions, context data, and/or the like, to identify a task of a user. The task recognition technique may take into account a plurality of variables to determine the task of the user. These variables may include other of the context data, for example, the sensor data, scheduling data, and/or the like. The variables may also include information received from other users, for example, the central device user, including audio, gesture, visual, and/or the like, data. Thus, if the central device user gives verbal instructions to perform a task, the system can utilize this information to identify the task the user is performing. Thus, the task recognition technique may utilizes natural language processing techniques, audio parsing techniques, information extraction techniques, image analysis techniques, gesture analysis techniques, and/or the like. The system may also take into account actions that are being taken by other users within proximity to the user. For example, the system may identify tasks that are currently being performed by other users. Essentially, the system utilizes the context data to determine the task or action that the user is currently supposed to be performing.

After receiving the context data at an information handling device, at 301, the software management system may identify that a permission status of the user from the central device restricts access of the user to the application during the predetermined time at 302. Identifying whether a user has access to an application may be as simple as comparing the application to a list of applications and the permission status of the user with respect to that application. In other words, the central device and/or user device may contain a data store that identifies applications and the permission status of the user with respect to that application. The permission status may be any permission status type regarding a user's access to an application. For example, the permission status may be allowed or authorized, not allowed or restricted, partially allowed or limited, a combination thereof, and/or the like. The central device may set up applications so that the user only access to particular features of an application, are only allowed to access the application at a particular time or for a particular length of time, and/or the like. These partial authorizations are considered limited authorizations. Upon identifying that the user is attempting to access an application, the software management system may access the data store and determine if the user is authorized to access the application and, if so, any restrictions upon that access.

When determining a permission status of the user, at 302, the system may utilize the input data received, at 301, to weigh the user selection input and the context data surrounding the software selected by the user, and further utilize the software management system in determining a permission status of the user. As will be understood, at 302, when discussing the determining of a permission status, collection of such context data may be weighed. In the system, and as mentioned prior, software attempting to be accessed by a user may be restricted and stored as restricted based upon the network that a device is connected to. In order to potentially bypass a restriction and thereafter accessing software and/or exclusive information or data, the system may use the software management system to determine, at 302, when it is appropriate to access such restricted software. A permission status is an authorization level, and in the system, based upon a present permission status, the software management system may determine if a user is authorized to access the desired software. In the system, a permission status is generated from the input received at 301, both user selection input and context data surrounding the user, and the software attempting to be accessed. The software management system may then determine, at 302, when a permission status should be adjusted to either permit access or adjusted to further restrict access to software. In the system, a user may be deemed authorized or unauthorized based on the determining, at 302.

In the system, to determine whether the central device should adjust the permission status of the user, the system may take into account one or more pieces of the context data. For example, the system may take into account a task of the user or other users, a schedule of the user, an application the user is attempting to access, the location of the user, the environment of the user, and/or the like. While a combination of context data may be used to determine if the user should have access to a restricted application, the disclosure will discuss individual context data analysis for ease of readability. However, it should be noted that the system can take into account a combination of context data and can also weight the context data with some data having a higher weighting than other context data. It should also be noted that determining whether the central device should adjust the permission status of the user can also be facilitated via use of the machine-learning model as previously discussed.

The system may take into account task-based context data to determine if the system should adjust the permission status of the user. For example, the system may take into account a plurality of variables in determining if the task indicates the user needs access to one or more restricted applications. In other words, the system determines whether the performance of the task indicates that the user needs to utilize an application that is currently restricted to a user. While the disclosure discusses a full restriction, it should be noted that this also includes a partial restriction that prevents the user from fully utilizing the application as needed based upon the context data. Thus, from the identified task, the system can determine different attributes of the task, for example, a task-type, at least one application associated with the task, potential application requirements for completing a task, a combination thereof, and/or the like. If the task requires the use of a restricted application, or an application whose restrictions prevent use of the application for the task, the software management system may determine that the central device should adjust the permission status of the user for the application.

It should also be noted that the task-based context data may also include task context data from other users in proximity to the user. For example, the system may determine that other users in proximity to the user are attempting to perform the same task as the user or attempting to access the same application as the user. Thus, based upon a particular number of users attempting to perform a task or access the same application at substantially the same time, the system may determine that the users were given instructions to perform the task and/or access the application. The system may require that a predetermined threshold of users attempt to perform a task and/or access an application before a permission status adjustment is needed. The predetermined threshold may be a percentage of the users, a specific number of users, a number set by the central device, and/or the like. In the system, the predetermined threshold level of users attempting to access software may be dynamically adjusted based on the context data received and the application attempting to be accessed. In other words, some applications may require a higher threshold of users than other applications before adjusting the permission status.

In order to prevent students from bypassing the permission settings using a cumulative effort of the students, the system may have checks in place to prevent such actions. For example, the system may require the recognition of a command by the instruction to access the application or perform the task. As another example, the system may set a particular user as a test or authorization user. In other words, if this user attempts to access the application in addition to other users, the system may determine it is a legitimate access request. This user or group of users may be identified by the instructor or central device. This user may also be learned over time utilizing a machine-learning model.

The software management system may take into account scheduling context data to determine if the system should adjust the permission status of the user. The system can determine that an event on the user's calendar or other scheduling context data would require or indicate that the user should have access to a normally restricted application. In the system, when a user is attempting to access a normally restricted application at a time that has been indicated as authorized or associated with an event that would indicate the application should be accessible, the system may determine that the central device should change the permission status of the user. Further, in the system, an authorized permission status based upon a scheduled event may only remain during the scheduled time of the associated event. For example, if a scheduled event for e-gaming runs from 1:00 PM to 2:00 PM, a user may operate under an authorized permission status for the gaming application for that hour. However, if the user attempts to access the e-gaming application outside of this scheduled event time, the user will not be able to access such an application because they are considered to have an unauthorized permission status. In the system, a permission status may be dynamically adjusted based upon a time of a scheduled event, for example, if the event starts late, finishes late, finishes early, gets rescheduled, and/or the like.

When the system determines, at 302, that a user, or group of users, is unauthorized to access the application even in view of the context data, the system may restrict the user(s) from accessing the desired software, at 304. In other words, the software management system may retain the restrictions that were placed on the user devices by the central device. However, when the system determines, at 302, that the context data indicates that the user, or group of users, should have access to an application and the central device has adjusted the permission status of the user based upon the context data, the system may permit access to the software, at 303.

In the system, when allowing access to the software, at 303, the system may verify with the central device user before changing the permission status of the user. In other words, instead of just automatically changing the permission status, the system may notify the instructor of the requested change and allow the user to accept or decline the permission status change. Whether the central device user is notified before the permission status is changed may be dependent on the central device user settings, based upon the application being accessed, and/or the like. Thus, whether the instructor is notified before the permission status is changed may change between applications that are being accessed. Regardless of whether the system waits to receive confirmation of a permission status change from an instructor, the system may notify the instructor of a permission status change. However, this is not strictly necessary. Confirmation of an instructor of a permission status change or input by the instructor indicating that the permission status change should not have been made (e.g., the instructor implements previous permission statuses after a change, the instructor resets the permission statuses, the instructor provides an input indicate displeasure at the change, etc.), can be utilized by the machine-learning model as feedback.

The length of time that the permission status is modified for access to an application may be dynamically determined for accessing the application. As mentioned above, in relation to acquiring schedule data for a user, the amount of time for access may fall in line with scheduled event. Additionally, or alternatively, the amount of time may be associated with instructions provided and received. For example, after accessing a video that was previously restricted, the software management system in combination with a task recognition technique may obtain instruction from the instructor to close out the video link after completion of watching the video. Therefore, in this example, the amount of time dynamically determined for permitting access to the application will be as long as the video. Thus, once the video is completed, the system will adjust the permission status of the user(s) from authorized to unauthorized. Additionally, or alternatively, permitting access to the software may be extended based upon instruction or may be cut off immediately based upon instruction from a determined instructor.

In the system, when permitting access to the software the length of time for access, or the amount of time that a user is acting under an authorized permission status, may depend on an application type. The software management system may access a storage device that houses predetermined amounts of authorized time for specific application types. As mentioned above, these predetermined amounts of times may be dynamically adjusted to coincide with instruction from an instructor. In addition, the predetermined amount of time for access, or operating under the authorized permission status, may be learned by use of historical data and previously accessing the same, or similar, piece of software. For example, the software management system may record an amount of time each authorized user utilizes a digital encyclopedia. From this collection of data, the software management system may perform one or more functions to calculate a routine amount of time that will be sufficient for subsequent use. The system may also utilize a machine-learning model to assist in making the determination regarding a length of accessibility. Other information or context data may also be utilized to determine a length of time for accessibility of an application.

After an amount of time for accessing a desired piece of application times out, either because of the end of a scheduled event, instructor authorization, application type in use, a combination thereof, and/or the like, the system may restrict access to the software at the information handling device. In this system, a retraction of an authorized permission status may reestablish the user with an unauthorized permission status, and therefore, restrict a user's ability to regain access to restricted application outside of the determined amount of time. In other words, upon receiving additional context data, which may be the same or similar data as that received at 301, the system may adjust the permission status of the user to restricted or unauthorized, and may, therefore, remove the allowed access to the application, thereby restricting access to the application.

The various embodiments herein thus describe a technical improvement over conventional methods for permitting access to restricted software. Rather than requiring a user to manually alter security and restriction settings associated with a network a user device is connected to, the current system and method utilizes a software management system in combination with context data of a user to determine when it is appropriate to access a desired application. The use of a task recognition technique employed by the software management system assists with determining and thereafter establishing an amount of time a user may operate under an authorized permission status without the need of additional user input. The system and method may push and adjust software restrictions based on the presence of input data associated with each piece of software attempting to be accessed by a user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device in operative communication with a central device during a predetermined time period, context data of a user of the information handling device;
identifying, from the context data and utilizing a software management system, that a permission status of the user from the central device restricts access of the user to an application on the information handling device during the predetermined time period; and
allowing, responsive to the central device adjusting the permission status of the user based upon the context data of the user, the user to access to the application.

2. The method of claim 1, wherein the receiving the context data comprises receiving data from a secondary application associated with the user.

3. The method of claim 2, wherein the receiving data from a secondary application comprises receiving data from a scheduling application.

4. The method of claim 2, wherein the receiving data from a secondary application comprises receiving data from an Internet browser.

5. The method of claim 1, wherein the receiving the context data comprises receiving data identifying a task of the user during the predetermined time period.

6. The method of claim 5, wherein the receiving the context data comprises receiving data identifying a task of other users utilizing other information handling device in operative communication with the central device during the predetermined time period.

7. The method of claim 6, wherein the allowing is responsive to the central device identifying the task of the other user is similar to the task of the other users during the predetermined time period.

8. The method of claim 1, comprising removing, responsive to the central device adjusting the permission status of the user based upon additional context data of the user, the allowed access to the application.

9. The method of claim 1, wherein the allowing is responsive to receiving input by a user of the central device at the central device authorizing the allowing.

10. The method of claim 1, wherein the central device comprises a device corresponding to an instructor and wherein the user comprises a student.

11. An information handling device, the information handling device comprising:
a processor;
a memory device that stores instructions that, when executed by the processor, causes the information handling device to:
receive, at the information handling device in operative communication with a central device during a predetermined time period, context data of a user of the information handling device;
identify, from the context data and utilizing a software management system, that a permission status of the user from the central device restricts access of the user to an application on the information handling device during the predetermined time period; and
allow, responsive to the central device adjusting the permission status of the user based upon the context data of the user, the user to access to the application.

12. The information handling device of claim 11, wherein the receiving the context data comprises receiving data from a secondary application associated with the user.

13. The information handling device of claim 12, wherein the receiving data from a secondary application comprises receiving data from a scheduling application.

14. The information handling device of claim 12, wherein the receiving data from a secondary application comprises receiving data from an Internet browser.

15. The information handling device of claim 11, wherein the receiving the context data comprises receiving data identifying a task of the user during the predetermined time period.

16. The information handling device of claim 15, wherein the receiving the context data comprises receiving data identifying a task of other users utilizing other information handling device in operative communication with the central device during the predetermined time period.

17. The information handling device of claim 16, wherein the allowing is responsive to the central device identifying the task of the other user is similar to the task of the other users during the predetermined time period.

18. The information handling device of claim 11, comprising removing, responsive to the central device adjusting the permission status of the user based upon additional context data of the user, the allowed access to the application.

19. The information handling device of claim 11, wherein the allowing is responsive to receiving input by a user of the central device at the central device authorizing the allowing.

20. A product, the product comprising:
a computer-readable storage device that stores executable code that, when executed by the processor, causes the product to:
receive, at an information handling device in operative communication with a central device during a predetermined time period, context data of a user of the information handling device;
identify, from the context data and utilizing a software management system, that a permission status of the user from the central device restricts access of the user to an application on the information handling device during the predetermined time period; and
allow, responsive to the central device adjusting the permission status of the user based upon the context data of the user, the user to access to the application.
